(19) United States
(12) Patent Application Publication
(10) Pub. No.: US 2007/0053322 A1
(43) Pub. Date: Mar. 8, 2007

(54) Method and apparatus for scheduling in a communication system

(75) Inventors: Won-Hyoung Park, Seoul (KR); Neung-Hyung Lee, Seoul (KR); Sae-Woong Bahk, Seoul (KR); Jin-Ghoo Choi, Seoul (KR)

Correspondence Address: DILWORTH & BARRESE, LLP, 333 EARLE OVINGTON BLVD., UNIONDALE, NY, 11553, US

(73) Assignees: SAMSUNG ELECTRONICS CO., LTD., Suwon-si (KR); Seoul National University Industry Foundation, Seoul (KR)

(21) Appl. No.: 11/517,752

(22) Filed: Sep. 8, 2006

Related U.S. Application Data
(60) Provisional application No. 60/715,069, filed on Sep. 8, 2005.

(30) Foreign Application Priority Data
Jun. 7, 2006 (KR) 51172/2006

(51) Int. Cl. H04Q 7/00

(52) U.S. Cl. 370/329

(57) ABSTRACT

A method and an apparatus for scheduling in a communication system take QoS of data into account. The method includes scheduling data to be transmitted to mobile stations according to a scheduling policy, wherein the scheduling policy is determined based on a fairness between the mobile stations and at least one of a temporal share request, a minimum throughput request, and a throughput share request.

### PRIORITY

This application claims the benefit under 35 U.S.C. §119(a) of applications filed in USPTO on Sep. 8, 2005 and assigned Ser. No. 60/715,069, and in the Korean Industrial Property Office on Jun. 7, 2006 and assigned Serial No. 2006-51172, the contents of which are hereby incorporated by reference.

### BACKGROUND OF THE INVENTION

1. Field of the Invention

The present invention relates to a communication system, and more particularly to a method and an apparatus for scheduling in a communication system.

2. Description of the Related Art

Recently, communication systems are being developed in order to provide a service which can transmit and receive a large capacity of data at a high speed. In particular, communication systems are being developed in order to provide various services with Quality of Service (QoS). In order to achieve reliable transmission/reception of data, it is necessary to perform scheduling based on a QoS of the data before the transmission/reception of the data. Therefore, various scheduling schemes have been proposed. Among the various scheduling schemes, one scheduling scheme is the Proportional Fairness (PF) scheme.

The PF scheme is a scheduling scheme which can maximize the total transmission quantity of a communication system while guaranteeing proportional fairness between mobile stations. However, the PF scheme takes only the fairness between mobile stations into account, and but does not consider the QoS of data in performing the scheduling. Therefore, the PF scheme is insufficient for reliable transmission/reception of the data. In this regard, there has been a request for a scheduling scheme which not only can guarantee fairness between mobile stations but also can take the QoS of the data into account, thereby improving the performance of the entire communication system.

### SUMMARY OF THE INVENTION

Accordingly, the present invention has been made to solve at least the above-mentioned problems occurring in the prior art, and an aspect of the present invention is to provide a method and an apparatus for scheduling in a communication system.

It is another aspect of the present invention to provide a method and an apparatus for scheduling in a communication system, which can take the QoS of data into account.

In order to accomplish these aspects, there is provided a method for scheduling in a communication system, the method includes scheduling data to be transmitted to mobile stations according to a scheduling policy, wherein the scheduling policy is determined based on a fairness between the mobile stations and at least one of a temporal share request, a minimum throughput request, and a throughput share request.

In accordance with another aspect of the present invention, there is provided an apparatus for scheduling in a communication system, the apparatus includes a scheduler for scheduling data to be transmitted to mobile stations according to a scheduling policy, wherein the scheduling policy is determined based on a fairness between the mobile stations and at least one of a temporal share request, a minimum throughput request, and a throughput share request.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a scheduling apparatus according to the present invention; and

FIG. 2 is a flowchart of the scheduling apparatus of the communication system according to the present invention.

### DETAILED DESCRIPTION OF THE PREFERRED EMBODIMENT

Hereinafter, preferred embodiments of the present invention will be described with reference to the accompanying drawings. In the following description, the same elements will be designated by the same reference numerals although they are shown in different drawings. Further, various specific definitions found in the following description are provided only to help general understanding of the present invention, and it will be apparent to those skilled in the art that the present invention can be implemented without such definitions. Further, in the following description of the present invention, a detailed description of known functions and configurations incorporated herein will be omitted when it may obscure the subject matter of the present invention.

The present invention proposes a method and an apparatus for scheduling while taking into consideration a Quality of Service (QoS). The present invention proposes a method and an apparatus for scheduling, which applies different scheduling policies according to the required QoS, thereby improving the performance of the entire communication system.

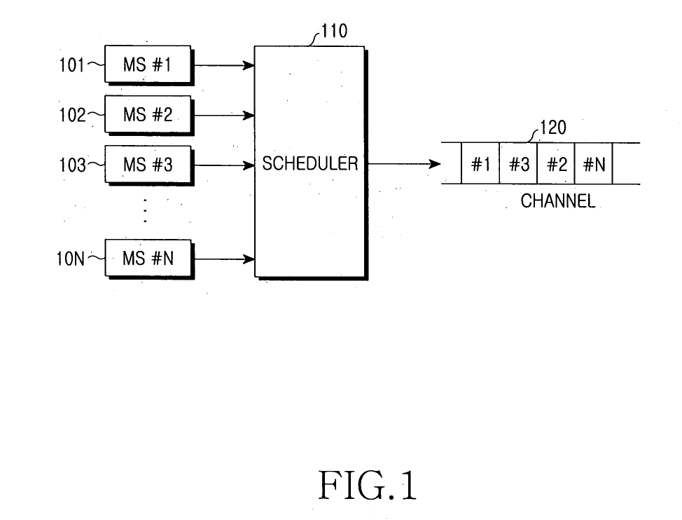

FIG. 1 is a block diagram of a scheduling apparatus according to the present invention.

Referring to FIG. 1, the scheduling apparatus includes a scheduler 110. In FIG. 1, reference numerals 101 to 10N denote data to be transmitted to the first mobile station MS#1 to the N^{th} mobile station MS #N, that is, data to be scheduled by the scheduler 110, respectively. Further, in FIG. 1, reference numeral 120 denotes resources allocated for transmission of data of a corresponding mobile station in accordance with a result of the scheduling, for example, channels. The scheduler 110 may perform scheduling by selecting one of the multiple scheduling policies. The term “scheduling policy” will be described in detail later.

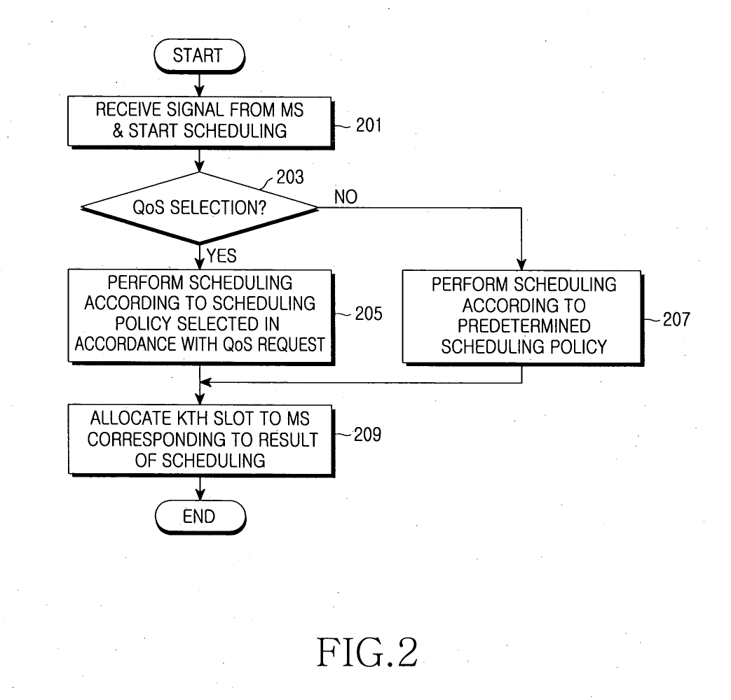

FIG. 2 is a flowchart of the scheduling apparatus of the communication system according to the present invention.

Referring to FIG. 2, first in step 201, the scheduling apparatus receives a signal from a mobile station and determines to start scheduling. The scheduling apparatus may perform the scheduling in accordance with a predetermined scheduling period, for example, frame by frame. Then, in step 203, the scheduling apparatus determines if it is necessary to select a QoS, in order to select a scheduling policy. When it is necessary to select a QoS as a result of the determination, the scheduling apparatus proceeds to step 205.

In step 205, the scheduling apparatus selects one scheduling policy from among the multiple scheduling policies in accordance with the required QoS, performs scheduling of data to be transmitted to mobile stations in accordance with the selected scheduling policy, and then proceeds to step 209. The required QoS will be described later in detail.

When it is unnecessary to select a QoS as a result of the determination in step 203, the scheduling apparatus proceeds to step 207. In step 207, the scheduling apparatus performs scheduling of data to be transmitted to mobile stations in accordance with a scheduling policy set in advance in the scheduling apparatus, and then proceeds to step 209. Although the process shown in FIG. 2 includes step 203 in which the scheduling apparatus determines whether to select one scheduling policy from multiple scheduling policies or to use a predetermined scheduling policy, it is of course possible to omit step 203 when the scheduling apparatus always uses one predetermined scheduling policy. In step 209, the scheduling apparatus allocates data to be transmitted to a mobile station to a corresponding slot (k^{th} slot) and then ends the process.

Hereinafter, various types of QoSs for determination of scheduling policies will be described.

1. Temporal Share Request

The temporal share request refers to a QoS which guarantees a probability for the number of slots to be allocated to a corresponding mobile station from among all slots available for scheduling, in consideration of the entire scheduling. The temporal share request refers to a QoS which guarantees a probability for slots to be allocated to the corresponding mobile station to be scheduled from among all slots available for scheduling. The temporal share request satisfies the condition defined by Equation (1)
P{Q*=m}≧αₘ (1)

In Equation (1), αₘ refers to a minimum probability by which the mobile station m can be allocated slots. In other words, the temporal share request refers to a QoS which guarantees allocation of slots over the minimum probability αₘ. Further, when the number of mobile stations in the communication system is M, a condition

$${\sum }_{m = 1}^{M} {α}_{m} \leq 1$$

must be also satisfied. A scheduling policy which satisfies the temporal share request as defined by Equation (1) can be defined by Equation (2)

$${Q}^{*} = arg {max}_{m} \{ {U}_{m}^{′} ( {\overline{{R}_{m}}}^{{Q}^{*}} ) {R}_{m} + {λ}_{m}^{*} \} \qquad ( 2 )$$

In Equation (2), the scheduling policy Q* corresponds to a policy for selecting a mobile station which has a maximum scheduling value from among the scheduling values U′ₘ( R̅ₘ̅^{Q*})Rₘ+λₘ* of all mobile stations. Further, Uₘ( R̅ₘ̅) corresponds to a utility of the mobile station m which has an average throughput of R̅ₘ̅, U′ₘ( R̅ₘ̅) corresponds to a first order gradient of the utility, and Rₘ corresponds to a data rate of the mobile station m at a corresponding slot. Further, λₘ* is an adaptively determined parameter, and a scheme for adaptively determining λₘ* will be described later.

2. Minimum Throughput Request

The minimum throughput request refers to a QoS which guarantees a minimum successful data transmission/reception rate which is finally obtained in consideration of the entire scheduling. The minimum throughput request refers to a QoS which guarantees a minimum throughput of a mobile station as a result of the entire scheduling.

That is, the minimum throughput request corresponds to a QoS which satisfies a condition as defined by Equation (3)
R̅ₘ̅^{Q*}≧βₘ (3)

In Equation (3), βₘ corresponds to the minimum throughput of the mobile station m. It is necessary to perform the scheduling according to a scheduling policy which can satisfy a throughput over βₘ. The scheduling policy which satisfies the minimum throughput request can be defined by Equation (4)

$${Q}^{*} = arg {max}_{m} \{ {U}_{m}^{′} ( {\overline{{R}_{m}}}^{{Q}^{*}} ) + {μ}_{m}^{*} \} {R}_{ m} \qquad ( 4 )$$

In Equation (4), the scheduling policy Q* corresponds to a policy for selecting a mobile station which has a maximum scheduling value from among the scheduling values {U′ₘ( R̅ₘ̅^{Q*})+μₘ*}Rₘ of all mobile stations. In Equation (4), μₘ* is an adaptively determined parameter, and a scheme for adaptively determining μₘ* will be described later.

3. Throughput Share Request

The throughput share request refers to a QoS which guarantees a resultant throughput of all mobile stations to reach a threshold throughput in view of the entire scheduling. The throughput share request refers to a QoS for guaranteeing a throughput share of a mobile station, which satisfies the condition as defined by Equation (5) for each mobile station

$${\overline{{R}_{m}}}^{{Q}^{*}} \geq {γ}_{m} {\sum }_{m = 1}^{M} {\overline{{R}_{m}}}^{{Q}^{*}} \qquad ( 5 )$$

In Equation (5), γₘ corresponds to a requested throughput share of the mobile station m. The throughput share request refers to a QoS which requires a throughput of at least γₘ be satisfied. Further, when the number of all mobile stations is M, γₘ must satisfy the condition of

$${\sum }_{m = 1}^{M} {γ}_{m} \leq 1.$$

The scheduling policy which satisfies the throughput share request can be defined by Equation (6)

$${Q}^{*} = arg {max}_{m} \{ {U}_{m}^{′} ( {\overline{{R}_{m}}}^{{Q}^{*}} ) + {ϕ}_{m}^{*} - π \} {R}_{m} \qquad ( 6 )$$

In Equation (6), the scheduling policy Q* corresponds to a policy for selecting a mobile station which has a maximum scheduling value from among the scheduling values {U′ₘ( R̅ₘ̅^{Q*})+φₘ*−π}Rₘ of all mobile stations. In Equation (6), π can be calculated by

$$π = {\sum }_{m = 1}^{M} {ϕ}_{m}^{*} {γ}_{m} ,$$

and φₘ* is an adaptively determined parameter. A scheme for adaptively determining φₘ* will be described later.
4. Combined Scheme Request

The combined scheme request refers to a QoS which simultaneously requests the three types of QoSs described above, in view of the entire scheduling. In order to satisfy the combined scheme request, it is necessary to use a scheduling policy as defined by Equation (7)

$${Q}^{*} = arg {max}_{m} \{ {U}_{m}^{′} ( {\overline{{R}_{m}}}^{{Q}^{*}} ) + {μ}_{m}^{*} + {ϕ}_{m}^{*} - π \} {R}_{m} + {λ}_{m}^{*} \qquad ( 7 )$$

In Equation (7), the QoS request quantities of the mobile station m are given as αₘ, βₘ, and γₘ. The scheduling policy Q* corresponds to a policy for selecting a mobile station which has a maximum scheduling value from among the scheduling values {U′ₘ( R̅ₘ̅^{Q*})+μₘ*+φₘ*−π}Rₘ+λₘ* of all mobile stations. In Equation (7), π can be calculated by

$$π = {\sum }_{m = 1}^{M} {ϕ}_{m}^{*} {γ}_{m} .$$

Further, in Equation (7), λₘ*, μₘ* and φₘ* are adaptively determined parameters, and schemes for adaptively determining λₘ*, μₘ*, and φₘ* will be described later.

In addition to the four QoSs described above, it is possible to consider the following three QoSs.

5. Temporal Share and Minimum Throughput Request

In consideration of the entire scheduling, the temporal share and minimum throughput request corresponds to a QoS which can simultaneously request the temporal share request and the minimum throughput request. This QoS can simultaneously request a probability for minimum slots to be scheduled for each mobile station and a throughput of the mobile station over a predetermined value.

6. Temporal Share and Throughput Share Request

In consideration of the entire scheduling, the temporal share and throughput share request corresponds to a QoS which can simultaneously request the temporal share request and the throughput share request. This QoS can simultaneously request a probability for minimum slots to be scheduled for a mobile station and a throughput share allocated to each mobile station by a scheduling system.

7. Minimum Throughput and Throughput Share Request

In consideration of the entire scheduling, the minimum throughput and throughput share request corresponds to a QoS which can simultaneously request the minimum throughput request and the throughput share request. This QoS can simultaneously request a throughput of the mobile station over a predetermined value and a throughput share allocated to each mobile station by a scheduling system.

Scheduling policies according to requested QoSs have been described above. the adaptive parameters λₘ*, μₘ*, and φₘ* used in the scheduling policies will be described. As used herein, equation for calculating λₘ*, μₘ*, and φₘ* are referred to as a parameter adaptation equations. The parameter adaptation equation in order to satisfy the QoS requests is defined by Equation (8)
λₘ^{k+1}=max(λₘ^{k}−δ^{k}gₘ^{k},0)
μₘ^{k+1}=max(μₘ^{k}−δₖhₘ^{k},0)
φₘ^{k+1}=max(φₘ^{k}−δₖpₘ^{k},0) (8)

In Equation (8), δ^{k} refers to a step sequence for parameter adaptation. The step sequence δ^{k} must satisfy conditions of δ^{k}>0,

$${lim}_{k -> ∞} {δ}^{k} = 0 , and {\sum }_{k = 1}^{∞} {δ}^{k} = ∞ .$$

Further, gₘ^{k}, hₘ^{k}, and pₘ^{k} are noisy observation values, which are different according to the requested QoSs. The noisy observation values gₘ^{k}, hₘ^{k}, and pₘ^{k} are calculated based on the scheduling result of each slot. The adaptive parameters λₘ*, μₘ*, and φₘ* can be calculated as below according to the requested QoSs.
1. Temporal Share Request:
gₘ^{k}I_{{Q}_{^{k}}_{=m}}−αₘ (9)

When the requested QoS is the temporal share request, Equation (9) is substituted for gₘ^{k} in Equation (8). The I_{{Q}_{^{k}}_{=m}} refers to an indication function which indicates 1 when Q^{k} selects the mobile station m, or 0 otherwise.

2. Minimum Throughput Request:
hₘ^{k}=RₘI_{{Q}_{^{k}}_{=m}}−βₘ (10)

When the requested QoS is the minimum throughput request, Equation (10) is substituted for hₘ^{k} in Equation (8).
3. Throughput Share Request:

$${p}_{m}^{k} = {R}_{m} {I}_{\{ {Q}^{k} = m \}} - {γ}_{m} {\sum }_{i = 1}^{M} {R}_{i} {I}_{\{ {Q}^{k} = i \}} \qquad ( 11 )$$

When the requested QoS is the throughput share request, Equation (11) is substituted for pₘ^{k} in Equation (8).

The parameter adaptation formula is calculated in order to guarantee the QoS according to each scheduling policy.

In scheduling according to the present invention as described above, not only the fairness between mobile stations in a communication system is guaranteed, but also the QoS of data is taken into account. Therefore, the present invention can improve the performance of the entire communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for scheduling in a communication system, the method comprising:
scheduling data to be transmitted to mobile stations according to a scheduling policy, wherein the scheduling policy is determined based on a fairness between the mobile stations and at least one of a temporal share request, a minimum throughput request, and a throughput share request.

2. The method as claimed in claim 1, wherein the scheduling policy is determined based on a fairness between the mobile stations and the temporal share request and corresponds to a Quality of Service (QoS) which guarantees a minimum probability of slots to be allocated to a corresponding mobile station from among all slots available for scheduling.

3. The method as claimed in claim 2, wherein the scheduling policy is determined by
$${Q}^{*} = arg {max}_{m} \{ {U}_{m}^{′} ( {\overline{{R}_{m}}}^{{Q}^{*}} ) {R}_{m} + {λ}_{m}^{*} \}$$
in order to satisfy P{Q*=m}≧αₘ,
wherein αₘ refers to a minimum probability of slots to be allocated to a mobile station m, Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, λₘ* refers to an adaptively determined parameter and is defined by λₘ^{k+1}=max(λₘ^{k}−δ^{k}gₘ^{k},0), δ^{k} refers to a step sequence for parameter adaptation, and gₘ^{k} refers to a noisy observation value.

4. The method as claimed in claim 1, wherein the scheduling policy is determined based on the fairness between the mobile stations and the minimum throughput request and corresponds to a QoS which guarantees a throughput over a predetermined value for each mobile station.

5. The method as claimed in claim 4, wherein the scheduling policy is determined by
$${Q}^{*} = arg {max}_{m} \{ {U}_{m}^{′} ( {\overline{{R}_{m}}}^{{Q}^{*}} ) + {μ}_{m}^{*} \} {R}_{ m}$$
in order to satisfy R̅ₘ̅^{Q*}≧βₘ,
wherein βₘ corresponds to the minimum throughput of the mobile station m, Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, μₘ* refers to an adaptively determined parameter and is defined by μₘ^{k+1}=max(μₘ^{k}−δₖhₘ^{k},0), δ^{k} refers to a step sequence for parameter adaptation, and hₘ^{k} refers to a noisy observation value.

6. The method as claimed in claim 1, wherein the scheduling policy is determined based on the fairness between the mobile stations and the throughput share request and corresponds to a QoS which guarantees a resultant throughput of all mobile stations to reach a threshold throughput.

7. The method as claimed in claim 6, wherein the scheduling policy is determined by
$${Q}^{*} = arg {max}_{m} \{ {U}_{m}^{′} ( {\overline{{R}_{m}}}^{{Q}^{*}} ) + {ϕ}_{m}^{*} - π \} {R}_{ m}$$
in order to satisfy
$${\overline{{R}_{m}}}^{{Q}^{*}} \geq {γ}_{m} {\sum }_{m = 1}^{M} {\overline{{R}_{m}}}^{{Q}^{*}} ,$$
wherein γₘ corresponds to a requested throughput share of the mobile station m, Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, π is defined by
$$π = {\sum }_{m = 1}^{M} {ϕ}_{m}^{*} {γ}_{m} ,$$
φₘ* is an adaptively determined parameter defined by φₘ^{k+1}=max(φₘ^{k}−δₖpₘ^{k},0), δ^{k} refers to a step sequence for parameter adaptation, and pₘ^{k} refers to a noisy observation value.

8. The method as claimed in claim 1, wherein the scheduling policy is determined based on the fairness between the mobile stations and a combined scheme request and corresponds to a QoS, which guarantees a minimum probability of slots to be allocated to a corresponding mobile station from among all slots, guarantees a throughput over a predetermined value for each mobile station, and guarantees a resultant throughput of all mobile stations to reach a threshold throughput, wherein the combined scheme request includes the temporal share request, the minimum throughput request, and the throughput share request.

9. The method as claimed in claim 8, wherein the scheduling policy is determined by
$${Q}^{*} = arg {max}_{m} \{ {U}_{m}^{′} ( {\overline{{R}_{m}}}^{{Q}^{*}} ) + {μ}_{m}^{*} + {ϕ}_{m}^{*} - π \} {R}_{ m} + {λ}_{m}^{*} ,$$
wherein Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, π is defined by
$$π = {\sum }_{m = 1}^{M} {ϕ}_{m}^{*} {γ}_{m} , {λ}_{m}^{*} , {μ}_{m}^{*} ,$$
and φₘ* are adaptively determined parameters, λₘ* is defined by λₘ^{k+1}=max(λₘ^{k}−δ^{k}gₘ^{k},0), μₘ* defined by μₘ^{k+1}=max(μₘ^{k}−δₖhₘ^{k},0), φₘ* is an adaptively determined parameter defined by φₘ^{k+1}=max(φₘ^{k}−δₖpₘ^{k},0), δ^{k} refers to a step sequence for parameter adaptation, and gₘ^{k}, hₘ^{k}, and pₘ^{k} refer to noisy observation values.

10. An apparatus for scheduling in a communication system, the apparatus comprising:
a scheduler for scheduling data to be transmitted to mobile stations according to a scheduling policy, wherein the scheduling policy is determined based on a fairness between the mobile stations and at least one of a temporal share request, a minimum throughput request, and a throughput share request.

11. The apparatus as claimed in claim 10, wherein the scheduling policy is determined based on the fairness between the mobile stations and the temporal share request and corresponds to a Quality of Service (QoS) which guarantees a minimum probability of slots to be allocated to a corresponding mobile station from among all slots available for scheduling.

12. The apparatus as claimed in claim 11, wherein the scheduling policy is determined by
$${Q}^{*} = arg { max}_{m} \{ {U}_{m}^{′} ( {\overline{{R}_{m}}}^{{Q}^{*}} ) {R}_{m} + {λ}_{m}^{*} \}$$
in order to satisfy P{Q*=m}≧αₘ,
wherein αₘ refers to a minimum probability of slots to be allocated to a mobile station m, Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, λₘ* refers to an adaptively determined parameter and is defined by λₘ^{k+1}=max(λₘ^{k}−δ^{k}gₘ^{k},0), δ^{k} refers to a step sequence for parameter adaptation, and gₘ^{k} refers to a noisy observation value.

13. The apparatus as claimed in claim 10, wherein the scheduling policy is determined based on the fairness between the mobile stations and the minimum throughput request and corresponds to a QoS which guarantees a throughput over a predetermined value for each mobile station.

14. The apparatus as claimed in claim 13, wherein the scheduling policy is determined by
$${Q}^{*} = arg { max}_{m} \{ {U}_{m}^{′} ( {\overline{{R}_{m}}}^{{Q}^{*}} ) + {μ}_{m}^{*} \} {R}_{ m}$$
in order to satisfy R̅ₘ̅^{Q*}≧βₘ,
wherein βₘ corresponds to the minimum throughput of the mobile station m, Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, μₘ* refers to an adaptively determined parameter and is defined by μₘ^{k+1}=max(μₘ^{k}−δₖhₘ^{k},0), δ^{k} refers to a step sequence for parameter adaptation, and hₘ^{k} refers to a noisy observation value.

15. The apparatus as claimed in claim 10, wherein the scheduling policy is determined based on the fairness between the mobile stations and the throughput share request and corresponds to a QoS which guarantees a resultant throughput of all mobile stations to reach a threshold throughput.

16. The apparatus as claimed in claim 15, wherein the scheduling policy is determined by
$${Q}^{*} = arg {max}_{m} \{ {U}_{m}^{′} ( {\overline{{R}_{m}}}^{{Q}^{*}} ) + {ϕ}_{m}^{*} - π \} {R}_{m}$$
in order to satisfy
$${\overline{{R}_{m}}}^{{Q}^{*}} \geq {γ}_{m} {\sum }_{m = 1}^{M} {\overline{{R}_{m}}}^{{Q}^{*}} ,$$
wherein γₘ corresponds to a requested throughput share of the mobile station m, Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, π is defined by
$$π = {\sum }_{m = 1}^{M} {ϕ}_{m}^{*} {γ}_{m} ,$$
φₘ* is an adaptively determined parameter defined by φₘ^{k+1}=max(φₘ^{k}−δₖpₘ^{k},0), δ^{k} refers to a step sequence for parameter adaptation, and pₘ^{k} refers to a noisy observation value.

17. The apparatus as claimed in claim 10, wherein the scheduling policy is determined based on the fairness between the mobile stations and a combined scheme request and corresponds to a QoS, which guarantees a minimum probability of slots to be allocated to a corresponding mobile station from among all slots available for scheduling, guarantees a throughput over a predetermined value for each mobile station, and guarantees a resultant throughput of all mobile stations to reach a threshold throughput, wherein the combined scheme request includes the temporal share request, the minimum throughput request, and the throughput share request.

18. The apparatus as claimed in claim 17, wherein the scheduling policy is determined by
$${Q}^{*} = arg {max}_{m} \{ {U}_{m}^{′} ( {\overline{{R}_{m}}}^{{Q}^{*}} ) + {μ}_{m}^{*} + {ϕ}_{m}^{*} - π \} {R}_{m} + {λ}_{m}^{*} ,$$
wherein Uₘ( R̅ₘ̅) corresponds to a utility of the mobile station m which has an average throughput of R̅ₘ̅, U′ₘ( R̅ₘ̅) corresponds to a first order gradient of the utility, Rₘ refers to a data rate of the mobile station m at a corresponding slot, π is defined by
$$π = {\sum }_{m = 1}^{M} {ϕ}_{m}^{*} {γ}_{m} , {λ}_{m}^{*} ,$$
μₘ* and φₘ* are adaptively determined parameters, λₘ* is defined by λₘ^{k+1}=max(λₘ^{k}−δ^{k}gₘ^{k},0), μₘ* is defined by μₘ^{k+1}=max(μₘ^{k}−δₖhₘ^{k},0), φₘ* is an adaptively determined parameter defined by φₘ^{k+1}=max(φₘ^{k}−δₖpₘ^{k},0), δ^{k} refers to a step sequence for parameter adaptation, and gₘ^{k}, hₘ^{k}, and pₘ^{k} refer to noisy observation values.
